(19) United States
(12) Patent Application Publication
(10) Pub. No.: US 2013/0173698 A1
(43) Pub. Date: Jul. 4, 2013

(54) Dynamic Content Adaptation

(71) Applicant: Ramandeep SETHI, Fremont, CA (US)

(72) Inventor: Ramandeep SETHI, Fremont, CA (US)

(21) Appl. No.: 13/730,219

(22) Filed: Dec. 28, 2012

Related U.S. Application Data
(60) Provisional application No. 61/581,939, filed on Dec. 30, 2011.

(51) Int. Cl. H04L 29/08

(52) U.S. Cl. CPC H04L 67/02
USPC 709/203

(57) ABSTRACT

A system, method and tangible computer-readable device for dynamic content adaptation on a wireless device are provided. A message including dynamic content adaptation for an application is received on a wireless device. A widget supporting dynamic content adaptation included in the message is retrieved on the wireless device. The widget is launched according to a parameter included in the dynamic content.

This application claims the benefit of U.S. Provisional Application No. 61/581,939, filed on Dec. 30, 2011 and is incorporated by reference in its entirety.

### FIELD

The embodiments relate generally to computer systems. More particularly, the embodiments relate to ways in which different forms of content may be adapted in dynamic, flexible, extensible, efficient, etc. ways to improve or enhance a computer system user's experience.

### BACKGROUND

As each day passes, the proliferation of computer-based devices progresses even further. In short, computer-based devices are everywhere—in the form of common desktop, laptop, pad, and other fixed and portable systems; in servers, minicomputers, mainfames, etc.; in television sets, television set-top boxes, Digital Video Recorders (DVRs), etc.; in appliances; in automobiles; etc.

One particularly popular class of computer-based devices is Wireless Devices (WDs). Examples of WDs include, possibly inter alia, mobile telephones, smartphones, handheld computers, Internet-enabled phones, pagers, radios, television sets, audio devices, car audio (and other) systems, recorders, text-to-speech devices, bar-code scanners, net appliances, mini-browsers, Personal Data Assistants (PDAs), etc.

The wireless telecommunications industry trade group CTIA—The Wireless Association forecasts that in mid-2011 there were approximately 323 million Mobile Subscribers (MSs, users of a WD) in the U.S., up from approximately 220 million MSs in the U.S. in mid-2006.

One consequence of the growth of WDs is the resulting ubiquitous nature of WDs—i.e., MSs carry them at almost all times and use them for an ever-increasing range of activities. For example, MSs employ their WDs to, possibly inter alia.

1) Exchange (Short Message Service (SMS), Multimedia Message Service (MMS), etc.) messages with other MSs (e.g., “Let's meet for dinner at 6”) through Peer-to-Peer, or P2P, messaging.

2) Secure information (such as, for example, weather updates, travel alerts, news updates, sports scores, etc.), participate in voting initiatives (such as, for example, with the television show American Idol®), interact with social networking sites, exchange E-mail messages, browse the Web, etc. through various of the available Application-to-Peer, or A2P, based service offerings.

3) Engage in Mobile Commerce (mCommerce, which broadly speaking, encompasses the buying and selling of merchant-supplied products, goods, and services through, with, etc. a WD) and Mobile Banking (mBanking, which, broadly speaking, encompasses performing various banking activities through, with, etc. a WD).

Regardless of its type (e.g., wired, wireless, or other), when a computer-based device receives a piece of content (including inter alia an E-Mail message, a SMS message, a MMS message, an Internet Protocol (IP) Multimedia Subsystem (IMS) message, a Voice Over IP (VoIP) quanta of data, a streaming quanta of data, raw data, a Web page, etc. containing any combination of one or more of inter alia text, a static image, audio data, video data, software application data, encoded data, etc.) the device needs instructions for how to handle the content.

Frequently such instructions are provided, statically, within a software application. That is, a programmer or a software developer specifies, as they write the source code for the software application, how the software application should process, handle, etc. content as such content is for example received at the software application. Once specified, such instructions are essentially fixed within the software application.

At times it would be desirable for such instructions to reside outside of a software application, to be adjustable, to be extensible, to be based on or perhaps provided with a piece of content, etc. to among other things alter, improve, enhance, etc. the experience of a user of a computer-based device; to address the features, limitations, etc. of a particular computer-based device based on possibly among other things aspects of the device itself, the user of the device (e.g., her permissions, etc.), the physical location of the device, etc.; to account for new types, forms, etc. of content as such become available; etc.

In other words, it would be desirable to have dynamic content adaptation.

While certain existing mechanisms (such as for example use of the Microsoft Windows® registry, use of the java.net.URL architecture, etc.) may support elements of dynamic content adaptation, the existing mechanisms all have weaknesses, deficiencies, etc.

Consequently a need exists for a flexible, easily extensible, efficient, etc. dynamic content adaptation mechanism.

Aspects of the embodiments fill the lacuna that was noted above while addressing, in new and innovatory ways, various of the not insubstantial challenges that are associated with same.

### BRIEF DESCRIPTION OF THE DRAWINGS/FIGURES

The accompanying drawings, which are incorporated herein and form part of the specification, illustrate the embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1 depicts an exemplary computer-based device (a computer system) through which embodiments may be implemented.

FIG. 2 depicts a computing environment, where embodiments may be implemented.

FIG. 3 illustrates various exchanges or interactions between a client and server, according to an embodiment.

FIG. 4 depicts a portion of a hypothetical arrangement that implements widgets, according to an embodiment.

The embodiments will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Various aspects of the embodiments may be implemented by any combination of one or more of inter alia software, firmware, hardware, etc. For simplicity of exposition certain software application, operating system, hardware, etc. arrangements are referenced in the discussion below but it will be readily apparent to one of ordinary skill in the relevant art that the embodiments can work with software, firmware, hardware, etc. implementations other than those described herein. Any such implementations suitable for performing the functions described herein can be used.

Note that in the discussion below a computer-based device may be referred to interchangeably as inter alia a computer system, a computer, a system, a computer-based device, etc.

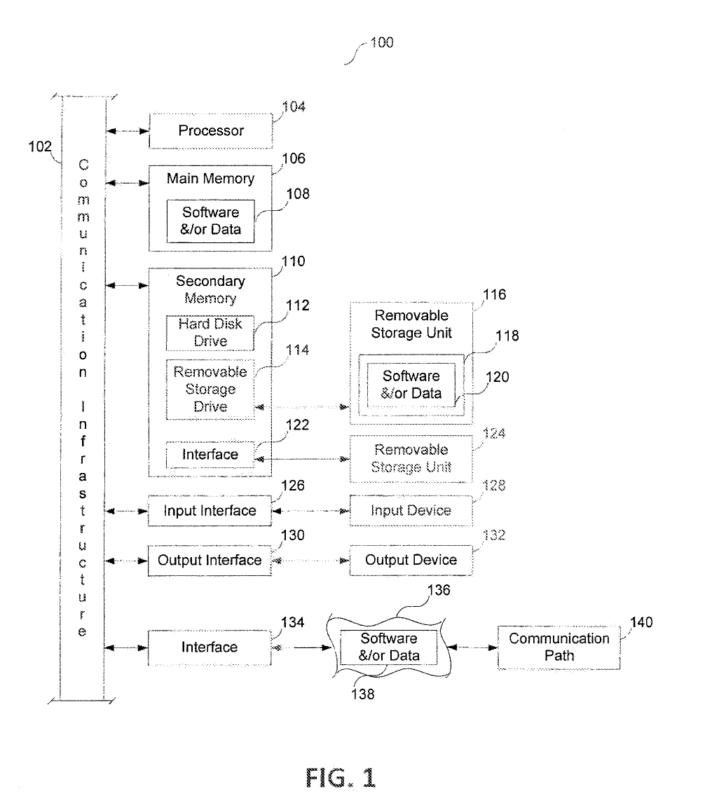

FIG. 1 illustrates an example computer system 100 in which the embodiments, or portions thereof, as described below can be implemented as computer-readable code. Various embodiments are described in terms of this example computer system 100. After reading this description, it will become apparent to a person skilled in the relevant art how to implement the embodiments using other computer systems and/or computer architectures.

Computer system 100 includes one or more processors, such as processor 104. Processor 104 can be a special purpose processor or a general purpose processor. Processor 104 is connected to a communication infrastructure 102 (for example, a bus or a network).

Computer system 100 also includes a main memory 106, preferably Random Access Memory (RAM), containing possibly inter alia computer software and/or data 108.

Computer system 100 may also include a secondary memory 110. Secondary memory 110 may include, for example, a hard disk drive 112, a removable storage drive 114, a memory stick, etc. A removable storage drive 114 may comprise a floppy disk drive, a magnetic tape drive, an optical disk drive, a flash memory, or the like. A removable storage drive 114 reads from and/or writes to a removable storage unit 116 in a well known manner. A removable storage unit 116 may comprise a floppy disk, magnetic tape, optical disk, etc. which is read by and written to by removable storage drive 114. As will be appreciated by persons skilled in the relevant art(s) removable storage unit 116 includes a computer usable storage medium 118 having stored therein possibly inter alia computer software and/or data 120.

In alternative implementations, secondary memory 110 may include other similar means for allowing computer programs or other instructions to be loaded into computer system 100. Such means may include, for example, a removable storage unit 124 and an interface 122. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 124 and interfaces 122 which allow software and data to be transferred from the removable storage unit 124 to computer system 100.

Computer system 100 may also include an input interface 126 and a range of input devices 128 such as, possibly inter alia, a keyboard, a mouse, etc.

Computer system 100 may also include an output interface 130 and a range of output devices 132 such as, possibly inter alia, a display, one or more speakers, etc.

Computer system 100 may also include a communications interface 134. Communications interface 134 allows software and/or data 138 to be transferred between computer system 100 and external devices. Communications interface 134 may include a modem, a network interface (such as an Ethernet card), a communications port, a Personal Computer Memory Card International Association (PCMCIA) slot and card, or the like. Software and/or data 138 transferred via communications interface 134 are in the form of signals 136 which may be electronic, electromagnetic, optical, or other signals capable of being received by communications interface 134. These signals 136 are provided to communications interface 134 via a communications path 140. Communications path 140 carries signals and may be implemented using wire or cable, fiber optics, a phone line, a cellular phone link, a Radio Frequency (RF) link or other communications channels.

As used in this document, the terms “computer program medium,” “computer usable medium,” and “computer readable medium” generally refer to media such as removable storage unit 116, removable storage unit 124, and a hard disk installed in hard disk drive 112. Signals carried over communications path 140 can also embody the logic described herein. Computer program medium and computer usable medium can also refer to memories, such as main memory 106 and secondary memory 110, which can be memory semiconductors (e.g. Dynamic Random Access Memory (DRAM) elements, etc.). These computer program products are means for providing software to computer system 100.

Computer programs (also called computer control logic) are stored in main memory 106 and/or secondary memory 110. Computer programs may also be received via communications interface 134. Such computer programs, when executed, enable computer system 100 to implement the embodiments as discussed herein. In particular, the computer programs, when executed, enable processor 104 to implement the processes of aspects of the embodiments, such as the steps, processes, actions, etc. that are discussed below. Accordingly, such computer programs represent controllers of the computer system 100. Where the embodiments are implemented using software, the software may be stored in a computer program product and loaded into computer system 100 using removable storage drive 114, interface 122, hard drive 112 or communications interface 134.

The embodiments are also directed to computer program products comprising software stored on any computer useable medium. Such software, when executed in one or more data processing devices, causes data processing device(s) to operate as described herein. Embodiments employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), nanotechnological storage device, etc.), and communication mediums (e.g., wired and wireless communications networks, local area networks, wide area networks, intranets, etc.).

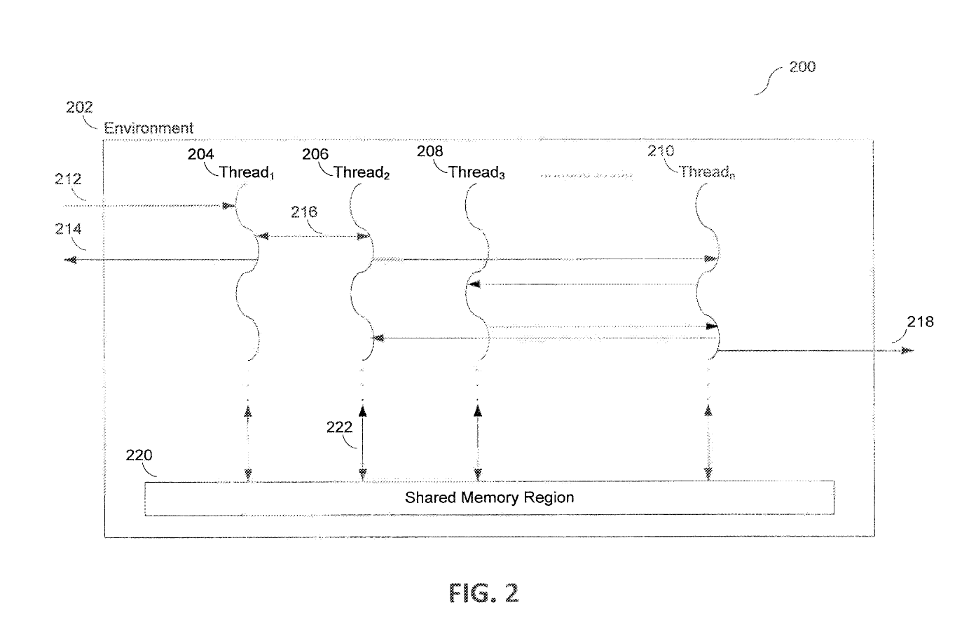

FIG. 2 and reference numeral 200 depict an environment 202 (e.g., implemented on or within, or containing aspects of, computer-based device 100 from FIG. 1) comprising possibly among other things a number of worker threads (including Thread₁ 204, Thread₂ 206, Thread₃ 208 . . . Threadₙ 210) and a Shared Memory Region 220. Various of the threads 204-210 may inter alia interact with external or outside entities (see for example 212, 214, and 218), interact with each other (see for example 216), and/or interact with a Shared Memory Region 220 (see for example 222).

It will be readily apparent to one of ordinary skill in the relevant art that numerous other environments, paradigms, etc. are easily possible.

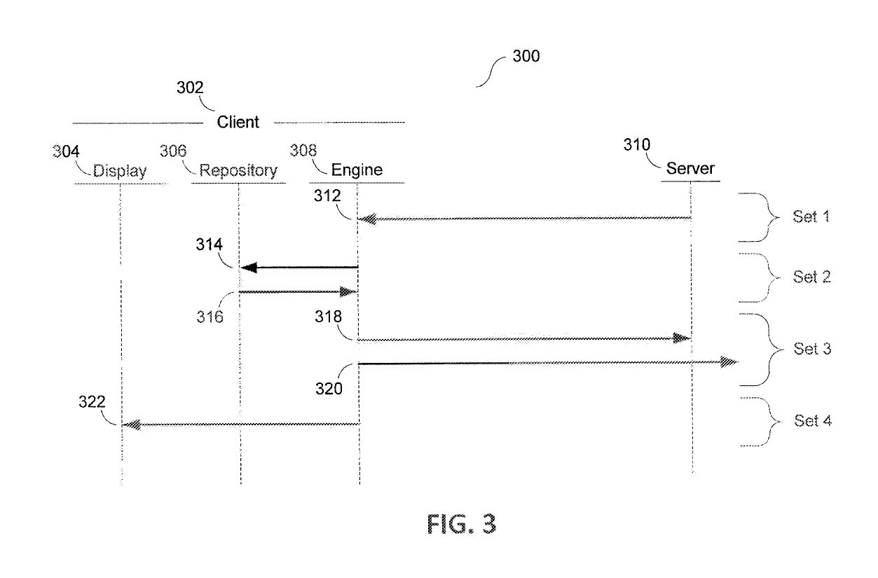

FIG. 3 and reference numeral 300 illustrate various of the exchanges or interactions that might occur between a client and server. Of interest and note in FIG. 3 are the following entities:

Client 302. A computer-based device such as inter alia a common desktop, laptop, pad, or other fixed or portable system; a WD such as for example a smartphone; a PDA; etc.

Client 302 Display 304. A display screen, mechanism, etc. on which inter alia information may be presented; a speaker through which inter alia audio information may be presented; etc.

Client 302 Repository 306. A storage facility within which inter alia information may be preserved. A repository 306 may be implemented through any combination of one or more of a conventional Relational Database Management Systems (RDBMS), an Object Database Management Systems (ODBMS), an in-memory Database Management Systems (DBMS), or any other equivalent facility.

Client 302 Engine 308. Aspects of the client 302 that are capable of inter alia receiving, sending, processing, etc. information (such as for example content); querying and updating a repository 306; updating a display 304; collecting client 302 user input; etc.

Server 310. A back-end server of inter alia a content provider, a service provider, a wireless carrier, etc.

It is important to note that:

1) The specific client 302 components that are presented in FIG. 3 (i.e., display 304, repository 306, and engine 308) are illustrative only and are not meant to be exhaustive, limiting, etc. It will be readily apparent to one of ordinary skill in the relevant art that numerous other components are easily possible within a client 302.

2) For simplicity of exposition just one server 310 is depicted in FIG. 3. It will be readily apparent to one of ordinary skill in the relevant art that any number of servers (one, two, three, etc.) are easily possible.

In FIG. 3 the exchanges that are collected under the designation Set 1 represent the activities that might take place as a server 310 supplies, sends, etc. information (including inter alia content) to a client 302 (see 312). Possibly inter alia:

1) Exchange 312 may comprise a string containing among other things a standards-based, custom, proprietary, etc. Uniform Resource Locator (URL) including among other things an identifier of a widget (described below, but in brief a collection of business logic, display mechanisms, etc. that supports possibly among other things dynamic content adaptation), one or more arguments that are to be supplied to the widget, etc. For example:

A) The string:
“sup://WidgetA?stock_symbol=SY&action=BUY”
   could indicate that ‘Widget A’ (which perhaps knows how to process, display, act on, etc. stock market data) should be launched and passed the arguments ‘stock_symbol=SY’ and ‘action=BUY.’

B) The string:
“sup://WidgetB?recordType=CUSTOMER&recordId=1023”
   could indicated that ‘Widget B’ (which perhaps knows how to retrieve, process, display, etc. records from a database) should be launched and passed the arguments ‘recordType=CUSTOMER’ and ‘recordId=1023.’

C) The string:
“sup://WidgetC?xml=<root><data>A1B2C3<%2Fdata><%2Froot>”
   could indicate that ‘Widget C’ (which perhaps knows how to parse, display, act on, etc. a body of Extensible Markup Language (XML) data) should be launched and passed the argument ‘xml=<root><data>A1B2C3<%2Fdata><%2Froot>.’

D) The string:
“sup://WidgetX?alertMsg=CLOSED&returnType=SMTP”
   could indicate that ‘Widget X’ (which perhaps knows how to process, display, etc. an update to a client user and accept client input) should be launched and passed the arguments ‘alertMsg=CLOSED’ and ‘returnType=SMTP.’

It is important to note that the strings that were presented above are illustrative only and it will be readily apparent to one of ordinary skill in the relevant art that numerous other strings, and string components/elements, are easily possible and indeed are fully within the scope of the embodiments. As just one example, a scheme or protocol designator other than ‘sup://’ (including a standards-based value such as for example ftp://, http://, or mailto:// or a custom or proprietary value) may be employed. As another example, the artifacts that were described above (including a widget identifier, one or more arguments that are to be supplied to a widget, etc.) may be included in, associated with, etc. inter alia an E-mail message, a (SMS, MMS, IMS, etc.) message, an Instant Messaging (IM) message, etc.

Certain types of messages (e.g., phishing emails, but can also be accomplished via SMS, MMS, IMS, IM, etc.) could be utilized to perform unauthorized invocation of widgets. Phishing can result in unauthorized access to data on client 302, and potential data corruption and loss. To avoid unauthorized invocation of widgets, various methods for mitigating security concerns may be implemented. One mitigating method is to include a nonce in a URL requested from server 310 by client 302. In one embodiment, a nonce may be a base 64 encoded string. In another embodiment, a nonce may be any base that is a power of two. When client 302 receives the URL the includes the nonce, client 302 parses the URL and authenticates the nonce.

Below is an example URL that includes a nonce:
Sup://widgetX?alertMsg=DealClosed&nonce=‘dGhpcyBpcyBhIHRlc3Q=’

If a nonce is not found in the URL, an application executing on client 302 may show a prompt to the user. The prompt may request an approval from the user regarding launching a widget. This way, a script or an application, that is included in a phishing email, etc., does not invoke a widget on client 302 without an acknowledgment or permission from a user.

2) Exchange 312 may comprise inter alia one or more widgets. As noted above and as will be described below, a widget is in essence a collection of business logic, display mechanisms, etc. that supports possibly among other things dynamic content adaptation. As a widget is received client 302 repository 306 may be updated to include inter alia aspects of a widget (such as for example name, version, source, argument list, sequencing or ordering details, etc.); aspects of the arguments, commands, etc. that were included in exchange 312 (as for example a set of name-value pairs); etc.

3) Exchange 312 may be sent automatically; may be based on some trigger; may be based on a predefined schedule; may be the result of a message, inquiry, action, etc. from client 302; etc.

The specific exchanges that were described above (as residing under the designation Set 1) are illustrative only and it will be readily apparent to one of ordinary skill in the relevant art that numerous other exchanges are easily possible and indeed are fully within the scope of the embodiments. For example, aspects of the exchange 312 may be repeated any number of times.

In FIG. 3 the exchanges that are collected under the designation Set 2 represent the activities that might take place as possibly among other things a client 302 engine 308 queries a client 302 repository 306 (see 314) and receives a response or reply (see 316). For example and inter alia:

1) A query (such as 314) may include among other things aspects of the information that was included in exchange 312 such as for example a widget identifier (e.g., ‘Widget A,’ ‘Widget X,’ etc.), a scheme or protocol identifier (such as ‘sup://’), etc.

2) A response (such as 316) may include among other things a widget (e.g., the widget itself, a pointer or reference to a location on the client 302 of the widget, etc.), an indication that the requested widget is not available (e.g., the widget does not exist on the client 302, the version of the widget on the client 302 is old or otherwise out of date, etc.), a list of the arguments that a widget expects, other information, etc.

The specific exchanges that were described above (as residing under the designation Set 2) are illustrative only and it will be readily apparent to one of ordinary skill in the relevant art that numerous other exchanges are easily possible and indeed are fully within the scope of the embodiments. For example, aspects of the sequence 314-316 may be repeated any number of times.

In FIG. 3 the exchanges that are collected under the designation Set 3 represent the activities that might take place as a client 302 engine 308 optionally retrieves, pulls, etc. content, data, information, etc. from any combination of one or more sources including server 310 (see 318) and one or more external sources (see 320). For example and inter alia:

1) Such actions may result in the retrieval of one or more widgets (for example, if client 302 does not currently have a required widget, if the version of a widget that client 302 has is old or has expired, etc.). As noted above, when a widget is received among other things client 302 repository 306 may be updated to include inter alia aspects of the widget (such as for example name, version, source, argument list, sequencing or ordering details, etc.); aspects of any arguments, commands, etc. that are to be passed to the widget (as for example a set of name-value pairs); etc.

2) Exchanges such as 318 and 320 may be initiated, directed, controlled, aided, etc. by aspects of one or more widgets.

3) Exchanges such as 318 and 320 may yield additional content, data, information, etc. any or all of which may be processed as described above (for example, in connection with exchange 312).

The specific exchanges that were described above (as residing under the designation Set 3) are illustrative only and it will be readily apparent to one of ordinary skill in the relevant art that numerous other exchanges are easily possible and indeed are fully within the scope of the embodiments. For example, aspects of the sequence 318-320 may be repeated any number of times.

In FIG. 3 the exchanges that are collected under the designation Set 4 represent the activities that might take place as a client 302 engine 308 optionally updates a client 302 display 304 (see 322). For example and inter alia:

1) Information that is outputted may take any number of forms including for example visual, audio, etc.

2) A client user may optionally be prompted for input and such input may be collected, processed, preserved, etc. Such input, and/or the processing of same, may result in additional actions, processing activities, etc. (e.g., as described above for Set 3, Set 2, and/or Set 1).

The specific exchanges that were described above (as residing under the designation Set 4) are illustrative only and it will be readily apparent to one of ordinary skill in the relevant art that numerous other exchanges are easily possible and indeed are fully within the scope of the embodiments. For example, aspects of the exchange 322 may be repeated any number of times.

The Set 1-Set 4 exchanges that were described above are illustrative only and it will be readily apparent to one of ordinary skill in the relevant art that numerous other exchanges are easily possible and indeed are fully within the scope of the embodiments. For example and possibly inter alia:

1) Exchange 312 may be carried by any combination of one or more of (SMS, MMS, IMS, IM, etc.) messaging, Unstructured Supplementary Service Data (USSD), etc. For example, under an SMS paradigm multiple (segmented) SMS messages might be employed to carry inter alia a string comprising a widget identifier, one or more arguments that are to be supplied to the widget, etc.

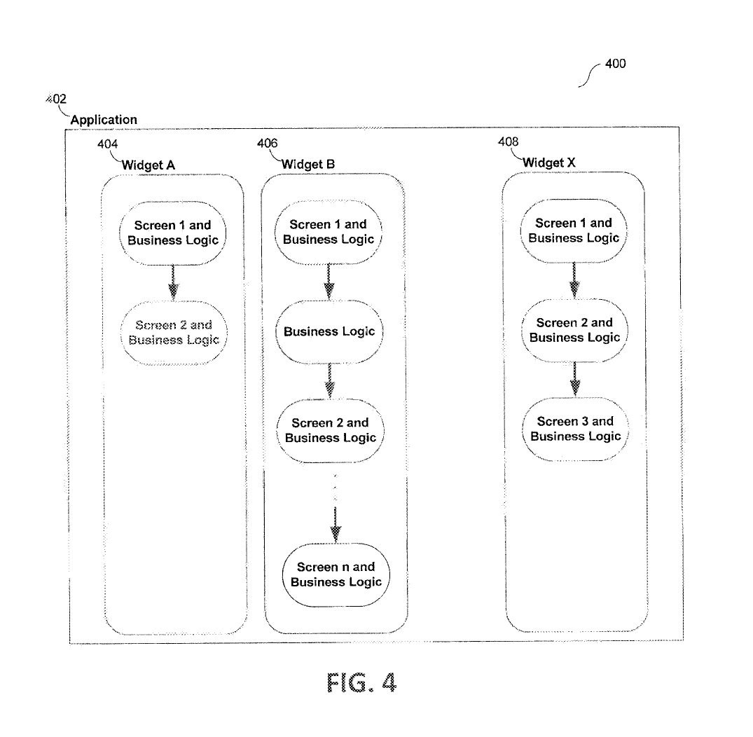

FIG. 4 and reference numeral 400 depict a portion of a hypothetical arrangement that implements widgets, according to an embodiment. As illustrated by the diagram, a hypothetical application 402 (operating on, residing within, etc. for example a computer-based device such as 100 from FIG. 1 and possibly employing aspects of arrangement 200 in FIG. 2) may contain inter alia a number of widgets including Widget A 404, Widget B 406, and Widget X 408.

In brief, a widget (such as Widget A 404 . . . Widget X 408) is an organized collection of business logic, display mechanisms, etc. that supports possibly among other things dynamic content adaptation to among other things alter, improve, enhance, etc. the experience of a user of a computer-based device; address the features, limitations, etc. of a particular computer-based device based on possibly among other things aspects of the device itself, the user of the device (e.g., her permissions, etc.), the physical location of the device, etc.; account for new types, forms, etc. of content as such become available; etc. A widget may:

1) Contain among other things any combination of one or more display mechanisms (such as screens, etc.) and one or more bodies of business logic. For example, a widget (e.g., Widget Y) might be associated with one particular type of content—E-mail—and may among other things know how to process a given E-mail message, appropriately update a display, optionally collect client user input, etc.

2) Be constructed using any combination of one or more commercially-available, custom, proprietary, etc. software development tools, programming languages (such as for example C, C++, Java, etc.), utilities, etc.

3) Have or otherwise be associated with inter alia a manifest file, definitional data, configuration data, etc. any or all of which may take the form of inter alia simple text, an XML document, structured data, raw data, etc.

4) Be autonomous (i.e., operate on its own).

5) Refer to, have a linkage to, invoke, leverage, etc. one or more other widgets. As a result, multiple widgets may be appropriately chained together, sequenced, etc. to yield a workflow mechanism.

6) Be pushed by a server to a client. Such an action may among other things be based on a predefined schedule, be based on some sort of trigger event, be a result of some client user activity, be associated with a particular piece of content (such as an E-mail message, etc.), be random, etc.

7) Be pulled by a client. Such an action may among other things be based on some client user activity, be associated with a particular piece of content, be the result of a client user registration process (at for example a Web site), etc.

8) As part of is processing activities communicate with systems, resources, etc. (a) resident on a client and/or (b) outside of or remote to a client (see for example exchanges 318 and 320 in FIG. 3).

9) Leverage information on the current physical location of a client (based on inter alia a Location-Based Service (LBS), a Global Positioning System (GPS), etc.) to for example offer enhanced security.

10) As part of is processing activities apply among other things one or more encryption/decryption techniques and/or one or more compression/decompression techniques.

11) Arrive at a client through any combination of one or more of inter alia (SMS, MMS, IMS, IM, etc.) messaging, raw data, E-Mail, USSD, etc.

As described above, as a widget is received at a client a repository may be updated to include inter alia aspects of the widget (such as for example name, version, source, argument list, sequencing or ordering details, etc.); mappings, associations, etc. for the widget; etc. Through such mappings, widget information, etc. a particular widget (e.g., ‘Widget Y’) might for example be associated with all E-mail messages and another widget (e.g., ‘Widget Z’) might for example be associated with just certain E-mail messages (having perhaps a particular kind of encoding, attachment, etc.) so that ‘Widget Y’ would be invoked for, applied to, etc. every E-mail message that was received and ‘Widget Z’ would additionally be invoked for, applied to, etc. just certain E-mail messages (with possibly any sequencing or ordering details identifying the invocation, application, etc. process—e.g., ‘Widget Y’ then ‘Widget Z’ or ‘Widget Z’ then ‘Widget Y’).

In an embodiment, widgets may also launch other widgets. Going back to a previous example, Widget Y may be invoked when client 302 receives an E-mail message. As Widget Y executes, Widget Y may determine that the E-mail message is of type that is associated with Widget Z. In this embodiment, Widget Y may launch Widget Z at a predetermined point in execution or as it completes execution.

In another embodiment, widgets may be chained for launching. For example, as Widget A executes, Widget A may automatically launch Widget B, and Widget B may automatically launch Widget C. The launch may occur at preconfigured points, or time intervals, and relieve the end user of client 302 from manually launching widgets.

In another embodiment, when one widget completes execution, it may cause client 302 to return to a previously executing widget or application. For example, application “MyApplication” may execute and launch Widget B. When Widget B completes execution, it may cause client 302 to return to “MyApplication.” A widget may use a parameter in the URL message, such as “returnURL” to cause client 302 to return to a previously executing widget. An example URL is replicated below:
sup://widgetX?alertMsg=DealClosed&returnURL=MyApplication://

When a widget completes execution, client 302 invokes a URL and identifies a “returnURL” parameter along with an application that is included in the “returnURL” parameter, such as “MyApplication.” In an embodiment, client 302 may invoke “MyApplication” using a URL handler.

In a further embodiment, a URL handler may also receive additional parameters that are passed to “MyApplication.” These parameters may indicate whether a widget has successfully completed execution. For example, a URL handler may receive parameters indicating a success or failure, code or message of a widget that completed execution. Example parameters passed to the URL handler are shown below:
MyApplication://returnCode=0&returnMessage=“done”

In the example above, “MyApplication” receives a parameter “returnCode” that is set to “0” and a parameter “returnMessage” that is set to “done.” In a further embodiment, the URL that is activated when a widget completes execution may be linked to a button or a function in MyApplication. For example, the URL may be linked to a logout or “sign out” button of “MyApplication.”

It is important to note that the specific elements and element arrangement that was presented in FIG. 4 are illustrative only and it will be readily apparent to one of ordinary skill in the relevant art that numerous other elements and/or element arrangements are easily possible.

It is important to note that the hypothetical examples that were presented above, which were described in the narrative and which were illustrated in the accompanying figures, are exemplary only. They are not intended to be exhaustive or to limit the invention to the specific forms disclosed. It will be readily apparent to one of ordinary skill in the relevant art that numerous alternatives to the presented examples are easily possible and, indeed, are fully within the scope of the embodiments.

What is claimed is:

1. A method comprising:
receiving a message including dynamic content adaptation for an application executing on a wireless device;
retrieving a widget configured to execute on the wireless device, wherein the widget supports the dynamic content adaptation included in the message; and
launching the widget according to a parameter included in the dynamic content adaptation.

2. The method of claim 1, wherein retrieving the widget comprises retrieving the widget including at least one of a business logic of an application executing on the wireless device and a display mechanism for displaying the dynamic content.

3. The method of claim 1, wherein receiving the message comprises receiving a string in the message, the string including the parameter identifying the widget.

4. The method of claim 1, wherein receiving the message comprises receiving a string in the message, the string including the parameter identifying an argument for the widget.

5. The method of claim 1, wherein receiving the message comprises receiving a string in the message, the string including the parameter identifying a resource locator.

6. The method of claim 1, wherein receiving the message comprises receiving the parameter in the message being a name-value pair.

7. The method of claim 1, wherein the receiving further comprises, receiving the message using an Internet, an E-mail, a short message service, a multimedia message service, an Internet Protocol Media Subsystem or instant messaging.

8. The method of claim 1, when the retrieving is not successful, further comprising:
requesting the widget over a network;
receiving the requested widget; and
storing the widget and attributes associated with the widget in a repository of the wireless device, prior to the launching, wherein at least one attribute corresponds to the parameter.

9. A system comprising:
a memory; and
at least one processor coupled to the memory and configured to:
receive a message including dynamic content adaptation for an application executing on a wireless device;
retrieve a widget configured to execute on the wireless device, wherein the widget supports the dynamic content adaptation included in the message; and
launch the widget according to a parameter included in the dynamic content adaptation.

10. The system of claim 9, wherein to retrieve the widget the processor is further configured to retrieve the widget including at least one of a business logic of an application executing on the wireless device and a display mechanism for displaying the dynamic content.

11. The system of claim 9, wherein to receive the message the processor is further configured to receive a string in the message, the string including the parameter identifying the widget.

12. The system of claim 9, wherein to receive the message the processor is further configured to receive a string in the message, the string including the parameter identifying an argument for the widget.

13. The system of claim 9, wherein to receive the message the processor is further configured to receive a string in the message, the string including the parameter identifying a resource locator.

14. The system of claim 9, wherein to receive the message the processor is further configured to receive the parameter in the message, the parameter in the message being a name-value pair.

15. The system of claim 9, wherein to receive the message, the processor is further configured to receive the message using an Internet, an E-mail, a short message service, a multimedia message service, an Internet Protocol Media Subsystem or instant messaging.

16. The system of claim 9, when the retrieving is not successful, the at least one processor is further configured to:
request the widget over a network;
receive the requested widget; and
store the widget and attributes associated with the widget in a repository of the wireless device, prior to the launching, wherein at least one attribute corresponds to the parameter.

17. A tangible computer-readable device having instructions stored thereon that, when executed by at least one computing device, causes the at least one computing device to perform operations comprising:
receiving a message including dynamic content adaptation for an application executing on a wireless device;
retrieving a widget configured to execute on the wireless device, wherein the widget supports the dynamic content adaptation included in the message; and
launching the widget according to parameters included in the dynamic content adaptation.

18. The tangible computer-readable device of claim 17, wherein retrieving the widget comprises retrieving the widget including at least one of a business logic of an application executing on the wireless device and a display mechanism for displaying the dynamic content.

19. The tangible computer-readable device of claim 1, wherein receiving the message comprises receiving a string in the message, the string including the parameters identifying the widget, identifying arguments for the widget, and identifying a resource locator.

20. The tangible computer-readable device of claim 17, wherein the receiving further comprises, receiving the message using an Internet, an E-mail, a short message service, a multimedia message service, an Internet Protocol Media Subsystem or instant messaging.
